(19) United States
(12) Patent Application Publication
(10) Pub. No.: US 2018/0026567 A1
(43) Pub. Date: Jan. 25, 2018

(54) CURRENT CONVERSION METHOD AND DEVICE AND VEHICLE COMPRISING SUCH A DEVICE

(71) Applicants: Universite Clermont Auvergne, Clermont Ferrand (FR); Centre National de la Recherche Scientifique, Paris (FR)

(72) Inventors: Khalil EL KHAMLICHI DRISSI, Cournon (FR); Abbas DEHGHANIKIADEHI, Clermont Ferrand (FR); Christophe PASQUIER, Dallet (FR)

(73) Assignees: Universite Celrmont Auvergne, Clermont Ferrabd (FR); Centre Natiaon de la Recherche Scientifique, Paris (FR)

(21) Appl. No.: 15/539,303

(22) PCT Filed: Jan. 6, 2016
(86) PCT No.: PCT/FR2016/050012

§ 371 Date: Jun. 23, 2017

(30) Foreign Application Priority Data
Jan. 6, 2015 (FR) 1550045

(51) Int. Cl. H02P 27/08; B60L 11/18; H02M 1/14; H02M 1/12; H02M 1/44; H02M 7/5395; H02P 21/22

(52) U.S. Cl. CPC H02P 27/08; H02M 7/5395; B60L 11/1803; H02P 21/22; H02M 1/12; H02M 1/44; H02M 1/14; B60L 2210/44; B60L 2220/14; H02M 2001/0058

(57) ABSTRACT

A power-conversion method for a vehicle including a three-phase electric motor, two three-phase inverters, each inverter being controlled via modulation of at least six spatial vectors, the output voltage of each inverter being given by a spatial vector referred to as “reference spatial vector”. The method includes the following steps: applying an activation sequence to the spatial vectors of one inverter, applying an activation sequence to the spatial vectors of the other inverter, subtracting the reference spatial vector of one inverter from the reference spatial vector of the other inverter and supplying the electric motor with electric power, the voltage inducing the electric power being relative to the vector resulting from the subtraction.

### CROSS-REFERENCE TO RELATED APPLICATIONS

This application is the National Stage of International Application No. PCT/FR2016/050012, having an International Filing Date of 6 Jan. 2016, which designated the United States of America, and which International application was published under PCT Article 21(2) as WO Publication No. 2016/110643 A1, and which claims priority from, and the benefit of, French Application No. 1550045, filed on 6 Jan. 2015, the disclosures of which are incorporated herein by reference in their entireties.

### BACKGROUND

### 1. Field

The presently disclosed embodiment is aimed at a current conversion method and device and a vehicle comprising such a device.

The presently disclosed embodiment applies to the field of electronics.

More particularly, the presently disclosed embodiment applies to the field of DC current conversion for powering a motor of an at least partially electrically propelled vehicle.

### 2. Brief Description of Related Developments

The major objectives of the electric energy conversion sector are to increase the autonomy and performance of electric and hybrid vehicles, in electric traction such as trains and trams, for example, but also in portable variable speed drives while limiting the costs.

The DC power supply devices of current hybrid vehicle motors comprise electric power supply sources, either autonomous or not autonomous, the delivered voltage of which must be increased in order that the voltage at the terminals of a three-phase inverter supplying current to an electric motor is sufficient.

However, the means used, such as voltage step-up choppers, for example, are expensive, take up a considerable volume and have a consequent weight which directly affects the performance of the vehicle. The means used are intended to attenuate the ripples of the output electric currents of the autonomous electric power supply source for delivering an electric current close to a DC current to the inverter. The efficiency of the device is approximately eighty-one percent.

Also, as the conventional means have more losses, it is necessary to have sufficient heat sinks to cool the equipment.

Finally, the Depth of Discharge (DOD) decreases exponentially with the number of discharges from the autonomous electric power supply source. The efficiency of the means currently used directly affects the speed of discharge and therefore the service life of the autonomous electric power supply source.

There are also devices comprising inverters comprising multiple stages. However, these devices exhibit losses in efficiency induced by a large number of switchings, zero voltages also called Zero Sequence Voltages (ZSV), as well as a Common-Mode Voltage (CMV).

### SUMMARY

The presently disclosed embodiment is aimed at remedying all or part of these drawbacks.

For this purpose, the presently disclosed embodiment is aimed at a current conversion method for a vehicle comprising:
a three-phase electric motor,
two three-phase inverters, each inverter being controlled via a modulation of at least six space vectors (or SVM for Space Vector Modulation), the output voltage of each inverter being given by a space vector referred to as a “reference space vector”

which comprises the following steps:
applying an activation sequence to the space vectors of one inverter,
applying an activation sequence to the space vectors of the other inverter,
subtracting the reference space vector of one inverter from the reference space vector of another inverter, and
supplying the electric motor with electric current, the voltage inducing the electric current being relative to the vector resulting from the subtraction.

Thanks to the active modulation of six space vectors, the number of switchings of the inverter switches is thirty-three percent, and thus the power loss is reduced. Consequently, the device forming the subject matter of the presently disclosed embodiment, makes it possible to reduce the peak and RMS common-mode current. Therefore, the control of a motor is improved and the service life of the motor is increased. Furthermore, there is a reduction in electromagnetic interference.

In addition, the ripple of the current consumed by an autonomous electric power supply source is reduced which helps to extend the service life of the autonomous electric power supply source and to limit the filtering capacity of a DC bus.

The harmonics, with regard to the drive unit, are also limited to a level of three percent with respect to the fundamental frequency which does not cause any damage by heating to the motor used.

Furthermore, the efficiency is approximately eighty-six percent with such a method. The control of each inverter independently by pulse width modulation (PWM) only uses the instantaneous values of the voltages of each phase and makes it possible to reduce the losses due to ZSV and CMV.

In some aspects, the activation sequences are configured so that the reference vectors are phase-shifted.

The advantage of these aspects is to reduce the amplitude of the CMV and ZSV.

In some aspects, each activation sequence of an inverter is configured so that two space vectors of the inverter, Vᵢ and Vᵢ₊₁, with i an integer between one and six, are activated consecutively by the activation sequence.

These aspects make it possible to limit the interference due to ZSV and CMV to a third of the DC input current of the inverters.

In some aspects, for an inverter Oₙ controlled according to a conventional modulation of eight space vectors Vi with i an integer between zero and seven, with n an integer between one and two:
the conventional duty cycle, ∝_{i,CSVM}ⁿ, of a vector Vᵢ activated by the activation sequence (260, 265) is given by the following formula:

$${∝}_{i , CSVM}^{n} = {V}_{ref , pu}^{n} ( \frac{sin ( i \frac{π}{3} - {θ}_{n} )}{sin ( \frac{π}{3} )} ) \qquad ( f )$$

the conventional duty cycle, ∝_{i+1,CSVM}ⁿ of the vector Vᵢ₊₁ activated consecutively by the activation sequence is given by the following formula:

$${∝}_{i + 1 , CSVM}^{n} = {V}_{ref , pu}^{n} ( \frac{sin ( {θ}_{n} - ( i - 1 ) \frac{π}{3} )}{sin ( \frac{π}{3} )} ) \qquad ( g )$$

where, i is an integer between one and six, θₙ is the phase of the conventional reference vector, and V_{ref,pu}ⁿ is the ratio between the norm of the conventional reference vector of the inverter n and the norm of the space vector Vᵢ,
the conventional reference space vector, \vec{V}_{ref,CSVM}ⁿ, of the inverter activated by the activation sequence is given by the following formula:

$${{V}^{->}}_{ref , CSVM}^{n} = {∝}_{i , CSVM}^{n} {{V}^{->}}_{i} + {∝}_{i + 1 , CSVM}^{n} {{V}^{->}}_{i + 1} + ( \frac{1 - {∝}_{i , CSVM}^{n} - {∝}_{i + 1 , CSVM}^{n}}{2} ) ( {{V}^{->}}_{0} + {{V}^{->}}_{7} ) \qquad ( j )$$

These aspects have the advantage of controlling the inverters according to a conventional space vector modulation.

In some aspects, for an inverter Oₙ, with n an integer between one and two:
the modified duty cycle, ∝ᵢⁿ, of a vector Vᵢ activated by the activation sequence (260, 265) is given by the following formula:

$${∝}_{i}^{n} = \frac{1}{2} - \frac{{∝}_{i + 1 , CSVM}^{n} - {∝}_{i , CSVM}^{n}}{2} = \frac{1}{2} - {V}_{ref , pu}^{n} sin ( {θ}_{n} - ( i - \frac{1}{2} ) \frac{π}{3} ) \qquad ( a )$$

the modified duty cycle, ∝ᵢ₊₁ⁿ, of the vector Vᵢ₊₁ activated consecutively by the activation sequence is given by the formula:

$${∝}_{i + 1}^{n} = \frac{1}{2} + \frac{{∝}_{i + 1 , CSVM}^{n} - {∝}_{i , CSVM}^{n}}{2} = \frac{1}{2} + {V}_{ref , pu}^{n} sin ( {θ}_{n} - ( i - \frac{1}{2} ) \frac{π}{3} ) \qquad ( b )$$

where, i is an integer between one and six, θₙ is the phase of the conventional reference vector, and V_{ref,pu}ⁿ is the ratio between the norm of the conventional reference vector of the inverter n and the norm of the space vector
the modified reference space vector, \vec{V}_{ref}ⁿ, of the inverter activated by the activation sequence is given by the following formula:

$${{V}^{->}}_{ref}^{n} = \frac{{{V}^{->}}_{i} + {{V}^{->}}_{i + 1}}{2} + ( {∝}_{i + 1 , CSVM}^{n} - {∝}_{i , CSVM}^{n} ) \frac{{{V}^{->}}_{i + 1} - {{V}^{->}}_{i}}{2} = {∝}_{i}^{n} {{V}^{->}}_{i} + {∝}_{i + 1}^{n} {{V}^{->}}_{i + 1} \qquad ( c )$$

The advantage of these aspects is to increase the maximum norm of the total space vector and therefore the voltage and the power supply current of the electric motor.

In some aspects, the activation sequences are independent.

These aspects have the advantage of being able to choose a phase shift between the reference space vectors of each inverter in order to increase the voltage of the electric current supplying the electric motor to the maximum. For example, the value of the voltage inducing the electric current supplying the electric motor may be doubled with a phase shift between the reference voltages between zero and one hundred and eighty degrees.

According to a second aspect, the presently disclosed embodiment is aimed at a current conversion device which comprises:
two three-phase inverters, each inverter being controlled via a modulation of at least six space vectors (or SVM for Space Vector Modulation), the output voltage of each inverter being given by a space vector referred to as a “reference space vector”,
means for applying an activation sequence to the space vectors of one inverter,
means for applying an activation sequence to the space vectors of the other inverter,
means for subtracting the reference space vector of one inverter from the reference space vector of another inverter and
means for connecting an electric power supply source.

Since the advantages, purposes and particular features of the device forming the subject matter of the presently disclosed embodiment are similar to those of the method forming the subject matter of the presently disclosed embodiment, they are not recalled here.

According to a third aspect, the presently disclosed embodiment is aimed at a vehicle which comprises a device forming the subject matter of the presently disclosed embodiment and a three-phase electric motor.

Since the advantages, purposes and particular features of the vehicle forming the subject matter of the presently disclosed embodiment are similar to those of the device forming the subject matter of the presently disclosed embodiment, they are not recalled here.

### BRIEF DESCRIPTION OF THE DRAWINGS

Other advantages, purposes and particular features of the disclosed embodiment will emerge from the non-restrictive description which follows of at least one particular aspect of the disclosed embodiment of a current conversion method and device and of a vehicle comprising such a device, referring to the accompanying drawings, in which:

FIG. 1 represents, schematically, a first particular aspect of a method forming the subject matter of the presently disclosed embodiment;

FIG. 2 represents, schematically, a first particular aspect of a device forming the subject matter of the presently disclosed embodiment;

FIGS. 3a and 3b represent, schematically, reference vectors in an orthonormal reference frame (α, β) in the context of the presently disclosed embodiment;

FIG. 4 represents, a vector representative of the input voltage of a three-phase electric motor in an orthonormal reference frame (α, β) in the context of the presently disclosed embodiment; and

FIG. 5 represents a particular aspect of a vehicle forming the subject matter of the presently disclosed embodiment.

### DETAILED DESCRIPTION

It should be noted that from now on the figures are not to scale.

The present description is given as non-restrictive, each feature of an aspect being capable of being combined with any other feature of any other aspect in an advantageous manner.

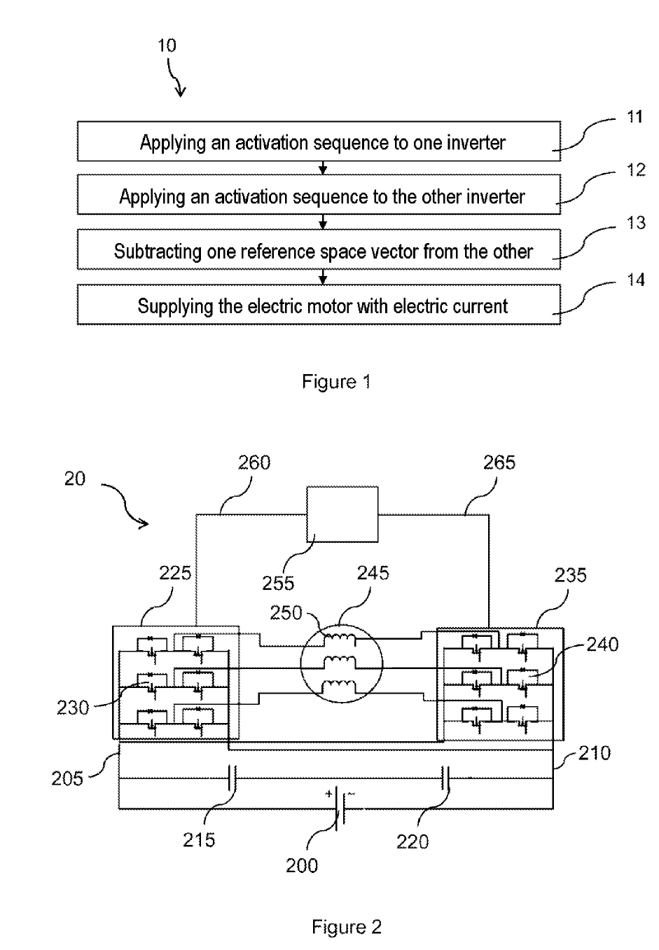

FIG. 1, depicts a particular aspect 10 of a method forming the subject matter of the presently disclosed embodiment for a vehicle 50 comprising:

a three-phase electric motor 245,

two three-phase inverters, each inverter being controlled via a modulation of at least six space vectors (or SVM for Space Vector Modulation), the output voltage of each inverter being given by a space vector referred to as a “reference space vector”,

which comprises the following steps:

applying 11 an activation sequence 260 to the space vectors of one inverter referred to as “inverter O1”,

applying 12 an activation sequence 265 to the space vectors of the other inverter referred to as “inverter O2”,

subtracting 13 the reference space vector of one inverter from the reference space vector of another inverter, and

supplying 14 the electric motor with electric current, the voltage inducing the electric current being relative to the vector resulting from the subtraction.

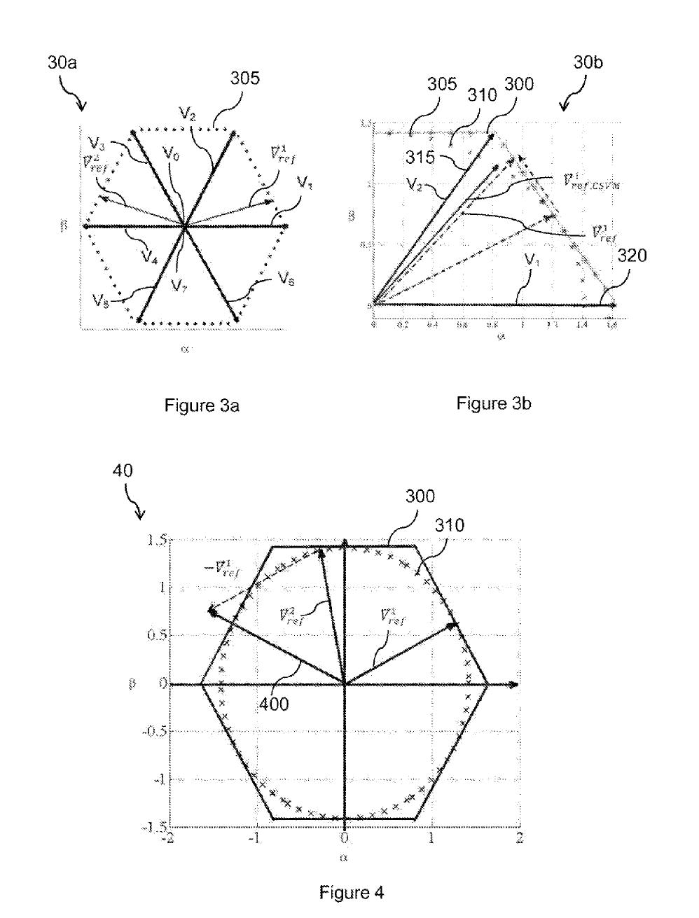

The six space vectors of each inverter, V₁, V₂, V₃, V₄, V₅, V₆, are defined as having the same norm and such that the angle between the direction of a vector Vᵢ and the direction of a vector Vᵢ₊₁, with i an integer between one and six, is sixty degrees. In defining the origin of the six space vectors V₁, V₂, V₃, V₄, V₅, V₆, at the same determined point of an orthonormal reference frame (α, β), the extremities of the space vectors V₁, V₂, V₃, V₄, V₅, V₆, define a regular hexagon. The vector V₁ is defined as being parallel to the axis a of the orthonormal reference frame (α, β). The construction of the space vectors can be seen in FIG. 3a.

The two vectors V₀ and V₇ correspond to zero vectors and are positioned at the center of the regular hexagon defined by the space vectors V₁, V₂, V₃, V₄, V₅, V₆.

The inverter, O1 or O2, comprises six power switches which are controlled by the means for applying an activation sequence, 260 or 265. Three pairs of power switches are mounted in parallel. The power switches have two states, the open state or the closed state. For activating one power switch per pair, in open or closed state, the other power switch is controlled in the other state. The space vectors V₁, V₂, V₃, V₄, V₅, V₆, each correspond to a different activation combination of six power switches. The activation sequence of the space vectors corresponds to an activation sequence of the power switches. The vector V₀ corresponds to the closure of the first switches receiving the current for each pair of switches. The vector V₇ corresponds to the opening of the first switches receiving the current for each pair of switches.

The electric motor comprises three phases pa, pb and pc.

Each activation sequence, 260 or 265, of an inverter, O1 or O2, is configured so that two space vectors of the inverter, Vᵢ and Vᵢ₊₁, with i an integer between one and six, are activated consecutively by the activation sequence, 260 or 265.

The activation sequence 260 of the inverter O1 comprises six subsequences implemented from the first subsequence to the sixth subsequence.

In the first subsequence, the vector V1 of the inverter O1 is activated for a duration t1+t2, then the vector V2 is activated for a duration Ts−(t1+t2). The duration Ts corresponds to a period of a clock signal. The duration Ts may be defined as the period of a subsequence.

In the second subsequence, the vector V2 of the inverter O1 is activated for a duration t1+t2, then the vector V3 is activated for a duration Ts−(t1+t2).

In the third subsequence, the vector V3 of the inverter O1 is activated for a duration t1+t2, then the vector V4 is activated for a duration Ts−(t1+t2).

In the fourth subsequence, the vector V4 of the inverter O1 is activated for a duration t1+t2, then the vector V5 is activated for a duration Ts−(t1+t2).

In the fifth subsequence, the vector V5 of the inverter O1 is activated for a duration t1+t2, then the vector V6 is activated for a duration Ts−(t1+t2).

The activation sequence 265 of the inverter O2 comprises six subsequences implemented from the first subsequence to the sixth subsequence.

In the first subsequence, the vector V3 of the inverter O1 is activated for a duration t1, then the vector V4 is activated for a duration Ts−t1.

In the second subsequence, the vector V4 of the inverter O1 is activated for a duration t1, then the vector V5 is activated for a duration Ts−t1.

In the third subsequence, the vector V5 of the inverter O1 is activated for a duration t1, then the vector V6 is activated for a duration Ts−t1.

In the fourth subsequence, the vector V6 of the inverter O1 is activated for a duration t1, then the vector V1 is activated for a duration Ts−t1.

In the fifth subsequence, the vector V1 of the inverter O1 is activated for a duration t1, then the vector V2 is activated for a duration Ts−t1.

In the sixth subsequence, the vector V2 of the inverter O1 is activated for a duration t1, then the vector V3 is activated for a duration Ts−t1.

The activation sequences 260 of the inverter O1 and 265 of the inverter O2 are activated consecutively, beginning with the first subsequence of each activation sequence in steps 11 and 12. Then the activation sequences, 260 and 265, are repeated until the command placing the electric motor in operation is halted. In some aspects, the activation sequence of the inverter O1 begins with a subsequence of the activation sequence and the activation sequence of the inverter O2 begins with a subsequence of the activation sequence such that the vectors activated in the subsequence are different from the vectors activated in the beginning subsequence of the activation sequence of the inverter O1.

The duration Ts is a predetermined period which is of the order of 100 μs according to the performance of the digital device used for controlling the inverters O1 and O2, for example. The more efficient the device is, the shorter Ts is. The arithmetic operations for determining the activation sequences, 260 and 265, are executable during the control period Ts.

The durations t1 and t2 are defined according to the formula e.

$$\{ \begin{matrix}t 1 = {T}_{s} min ( {∝}_{i}^{1} , {∝}_{i}^{2} ) \\ t 2 = {T}_{s} max ( {∝}_{i}^{1} , {∝}_{i}^{2} )\end{matrix} \qquad ( e )$$

The duty cycle ∝ᵢ¹ is defined in the formula (a) relating to the inverter O1.

The duty cycle ∝ᵢ² is defined in the formula (a) relating to the inverter O2.

In aspects in which a conventional space vector modulation is implemented, the durations t1 and t2 are defined according to the formula e_{CSVM}.

$$\{ \begin{matrix}t 1 = {T}_{s} min ( {∝}_{i , CSVM}^{1} , {∝}_{i , CSVM}^{2} ) \\ t 2 = {T}_{s} max ( {∝}_{i , CSVM}^{1} , {∝}_{i , CSVM}^{2} )\end{matrix} \qquad ( {e}_{CSVM} )$$

The two reference vectors V_{ref,pu}¹ and V_{ref,pu}², of the inverters O1 and O2 respectively, may be equal.

In some aspects, the activation sequences, 260 and 265, are independent. The inverters are therefore controlled independently.

The activation sequences, 260 and 265, are configured so that the reference vectors are phase-shifted. The three-phase electric motor is supplied with current by three phases. If the currents of each phase of the electric motor are in phase, the electric motor does not operate. A phase-shift of the reference vectors involves a phase-shift between the phases of the operating electric motor.

The duty cycles of each active vector Vᵢ and of the vector activated consecutively Vᵢ₊₁ obtained by a Conventional Space Vector Modulation (CSVM) are defined in the formulas f and g. A duty cycle may be defined as being the activation time of a vector divided by the duration Ts. The following formulas are defined for an inverter Oₙ controlled according to a conventional modulation of eight space vectors V₁ with i an integer between zero and seven, with n an integer between one and two.

The conventional duty cycle, ∝_{i,CSVM}ⁿ, of a vector Vᵢ activated by the activation sequence (260, 265) is given by the following formula:

$${∝}_{i , CSVM}^{n} = {V}_{ref , pu}^{n} ( \frac{sin ( i \frac{π}{3} - {θ}_{n} )}{sin ( \frac{π}{3} )} ) \qquad ( f )$$

The conventional duty cycle, ∝_{i+1,CSVM}ⁿ of the vector Vᵢ₊₁ activated consecutively by the activation sequence is given by the formula:

$${∝}_{i + 1 , CSVM}^{n} = {V}_{ref , pu}^{n} ( \frac{sin ( {θ}_{n} - ( i - 1 ) \frac{π}{3} )}{sin ( \frac{π}{3} )} ) \qquad ( g )$$

where, i is an integer between one and six, θₙ is the phase of the conventional reference vector, and V_{ref,pu}ⁿ is the ratio between the norm of the conventional reference vector of the inverter n and the norm of the space vector Vᵢ.

The conventional reference space vector, \vec{V}_{ref,CSVM}ⁿ of the inverter activated by the activation sequence is given by the following formula:

$${{V}^{->}}_{ref , CSVM}^{n} = {∝}_{i , CSVM}^{n} {{V}^{->}}_{i} + {∝}_{i + 1 , CSVM}^{n} {{V}^{->}}_{i + 1} + ( \frac{1 - {∝}_{i , CSVM}^{n} - {∝}_{i + 1 , CSVM}^{n}}{2} ) ( {{V}^{->}}_{0} + {{V}^{->}}_{7} ) \qquad ( j )$$

In these aspects, step 13 is performed according to the formula d_{CSVM} assuming that each inverter, O1 and O2, is connected to the same electric power supply source. If the norms of the reference vectors of the inverters, O1 and O2, are equal, the formula d is simplified and leads to the formula h_{CSVM}.

$$\begin{matrix}{{V}^{->}}_{motor input} = {{V}^{->}}_{ref , CSVM}^{1} - {{V}^{->}}_{ref , CSVM}^{2} & ( {d}_{CSVM} ) \\ {{V}^{->}}_{motor input} = 2 ‖ {{V}^{->}}_{ref , CSVM} ‖ sin ( \frac{{θ}_{1} - {θ}_{2}}{2} ) {e}^{j ( \frac{π + {θ}_{1} + {θ}_{2}}{2} )} & ( {h}_{CSVM} )\end{matrix}$$

With θ₁ and θ₂ the phase of the conventional reference vector of the inverter O1 and the inverter O2 respectively, \vec{V}_{motor input} the vector representative of the input voltage of the three-phase electric motor 245 and ∥\vec{V}_{ref,CSVM}∥ the norm of the reference vectors of the inverters O1 and O2, assumed to be equal.

The voltage inducing the electric current is given by the formula i_{CSVM} in which V_{dc} is the value of the output voltage of the electric power supply source.

$$‖ {{V}^{->}}_{motor input} ‖ = 2 ‖ {{V}^{->}}_{ref , CSVM} ‖ sin ( \frac{{θ}_{1} - {θ}_{2}}{2} ) \leq \sqrt{2} {V}_{dc} sin ( \frac{{θ}_{1} - {θ}_{2}}{2} ) \qquad ( {i}_{CSVM} )$$

The duty cycles ∝_{i,CSVM} and ∝_{i+1,CSVM} defined in the formulas f and g are modified to obtain the duty cycles ∝ᵢ and ∝ᵢ₊₁. The duty cycles, ∝ᵢ and ∝ᵢ₊₁, are such that the time during which the vector Vᵢ is active is equal to the time during which the vector Vᵢ₊₁ is inactive in the same subsequence and vice versa. Thanks to the active modulation of six space vectors, the number of switchings of the inverter is reduced and the maximum value of the modified reference vector of the inverter is increased. In addition, two phases of the electric motor out of the three phases pa, pb and pc, are supplied with positive or negative electric current, only one phase undergoing changes.

For an inverter Oₙ, with n an integer between one and two, the modified duty cycles are given by the formulas a and b.

The modified duty cycle, ∝ᵢⁿ, of a vector Vᵢ activated by the activation sequence (260, 265) is given by the following formula:

$${∝}_{i}^{n} = \frac{1}{2} - \frac{{∝}_{i + 1 , CSVM}^{n} - {∝}_{i , CSVM}^{n}}{2} = \frac{1}{2} - {V}_{ref , pu}^{n} sin ( {θ}_{n} - ( i - \frac{1}{2} ) \frac{π}{3} ) \qquad ( a )$$

The modified duty cycle, ∝ᵢ₊₁ⁿ, of the vector Vᵢ₊₁ activated consecutively by the activation sequence is given by the formula:

$${∝}_{i + 1}^{n} = \frac{1}{2} + \frac{{∝}_{i + 1 , CSVM}^{n} - {∝}_{i , CSVM}^{n}}{2} = \frac{1}{2} + {V}_{ref , pu}^{n} sin ( {θ}_{n} - ( i - \frac{1}{2} ) \frac{π}{3} ) \qquad ( b )$$

where, i is an integer between one and six, θₙ is the phase of the conventional reference vector, and V_{ref,pu}ⁿ is the ratio between the norm of the conventional reference vector of the inverter n and the norm of the space vector Vᵢ.

And the modified reference space vector, \vec{V}_{ref}ⁿ of the inverter activated by the activation sequence is given by the following formula:

$${{V}^{->}}_{ref}^{n} = \frac{{{V}^{->}}_{i} + {{V}^{->}}_{i + 1}}{2} + ( {∝}_{i + 1 , CSVM}^{n} - {∝}_{i , CSVM}^{n} ) \frac{{{V}^{->}}_{i + 1} - {{V}^{->}}_{i}}{2} = {∝}_{i}^{n} {{V}^{->}}_{i} + {∝}_{i + 1}^{n} {{V}^{->}}_{i + 1} \qquad ( c )$$

Step 13 is performed according to the formula d assuming that each inverter, O1 and O2, is connected to the same electric power supply source. If the norms of the reference vectors of the inverters, O1 and O2, are equal, the formula d is simplified and leads to the formula h.

$$\begin{matrix}{{V}^{->}}_{motor input} = {{V}^{->}}_{ref}^{1} - {{V}^{->}}_{ref}^{2} & ( d ) \\ {{V}^{->}}_{motor input} = 2 ‖ {{V}^{->}}_{ref} ‖ sin ( \frac{{θ}_{1} - {θ}_{2}}{2} ) {e}^{j ( \frac{π + {θ}_{1} + {θ}_{2}}{2} )} & ( h )\end{matrix}$$

With θ₁ and θ₂ the phase of the conventional reference vector of the inverter O1 and the inverter O2 respectively, \vec{V}_{motor input} the vector representative of the input voltage of the three-phase electric motor 245 and ∥\vec{V}_{ref}∥ the norm of the reference vectors of the inverters O1 and O2, assumed to be equal.

The voltage inducing the electric current is given by the formula i in which V_{dc} is the value of the output voltage of the electric power supply source.

$$‖ {{V}^{->}}_{motor input} ‖ = 2 ‖ {{V}^{->}}_{ref} ‖ sin ( \frac{{θ}_{1} - {θ}_{2}}{2} ) \leq \frac{6 \sqrt{6}}{{π}^{2}} {V}_{dc} sin ( \frac{{θ}_{1} - {θ}_{2}}{2} ) \qquad ( i )$$

Preferably, the angle between the reference vectors of the inverters O1 and O2 is greater than sixty degrees.

The activation sequences are such that, for the first subsequence, for example:

for the duration t1, the phase pa is supplied by the positive output voltage of the electric power supply source divided by two and the phase pb is supplied by the negative output voltage of the electric power supply source.

for the duration t2, the phase pa is supplied by the positive output voltage of the electric power supply source, the phase pb is supplied by the negative output voltage of the electric power supply source and the phase pc is supplied by the negative output voltage of the electric power supply source and

for the duration Ts−(t1+t2), the phase pa is supplied by the positive output voltage of the electric power supply source and the phase pc is supplied by the negative output voltage of the electric power supply source.

The method 10 forming the subject matter of the presently disclosed embodiment makes it possible to calculate a ZSV for each inverter. The ZSV of the device forming the subject matter of the disclosed embodiment being the subtraction of the ZSV of the inverter O1 by the ZSV of the inverter O2. The CMV of the device forming the subject matter of the disclosed embodiment is calculated as the average of the ZSVs of the inverters O1 and O2.

TABLE 1
ZSV values of the device forming the subject
matter of the presently disclosed embodiment for each activation
subsequence

| Inverter O1 | 1 | 2 | 3 | 4 | 5 | 6 |
|---|---|---|---|---|---|---|
| Inverter O2 | | | | | | |
| 1 | 0 | $\frac{{V}_{dc}}{6}$ | 0 | $\frac{{V}_{dc}}{6}$ | 0 | $\frac{{V}_{dc}}{6}$ |
| 2 | $- \frac{{V}_{dc}}{6}$ | 0 | $- \frac{{V}_{dc}}{6}$ | 0 | $- \frac{{V}_{dc}}{6}$ | 0 |
| 3 | 0 | $\frac{{V}_{dc}}{6}$ | 0 | $\frac{{V}_{dc}}{6}$ | 0 | $\frac{{V}_{dc}}{6}$ |
| 4 | $- \frac{{V}_{dc}}{6}$ | 0 | $- \frac{{V}_{dc}}{6}$ | 0 | $- \frac{{V}_{dc}}{6}$ | 0 |
| 5 | 0 | $\frac{{V}_{dc}}{6}$ | 0 | $\frac{{V}_{dc}}{6}$ | 0 | $\frac{{V}_{dc}}{6}$ |
| 6 | $- \frac{{V}_{dc}}{6}$ | 0 | $- \frac{{V}_{dc}}{6}$ | 0 | $- \frac{{V}_{dc}}{6}$ | 0 |

Table 1 displays the ZSV values of the method 10 and the device 20 forming the subject matter of the presently disclosed embodiment for each activation subsequence. These values are the positive output voltage value of the electric power supply source divided by three, zero or the negative output voltage value of the electric power supply source divided by three, the value of the output voltage of the electric power supply source being

$$\frac{{V}_{dc}}{2} .$$

TABLE 2
CMV values of the device forming the subject
matter of the presently disclosed embodiment for each activation
subsequence

| Inverter O1 | 1 | 2 | 3 | 4 | 5 | 6 |
|---|---|---|---|---|---|---|
| Inverter O2 | | | | | | |
| 1 | $- \frac{{V}_{dc}}{6}$ | 0 | $- \frac{{V}_{dc}}{6}$ | 0 | $- \frac{{V}_{dc}}{6}$ | 0 |
| 2 | 0 | $\frac{{V}_{dc}}{6}$ | 0 | $\frac{{V}_{dc}}{6}$ | 0 | $\frac{{V}_{dc}}{6}$ |
| 3 | $- \frac{{V}_{dc}}{6}$ | 0 | $- \frac{{V}_{dc}}{6}$ | 0 | $- \frac{{V}_{dc}}{6}$ | 0 |
| 4 | 0 | $\frac{{V}_{dc}}{6}$ | 0 | $\frac{{V}_{dc}}{6}$ | 0 | $\frac{{V}_{dc}}{6}$ |
| 5 | $- \frac{{V}_{dc}}{6}$ | 0 | $- \frac{{V}_{dc}}{6}$ | 0 | $- \frac{{V}_{dc}}{6}$ | 0 |
| 6 | 0 | $\frac{{V}_{dc}}{6}$ | 0 | $\frac{{V}_{dc}}{6}$ | 0 | $\frac{{V}_{dc}}{6}$ |

Table 2 displays the CMV values of the method 10 and the device 20 forming the subject matter of the presently disclosed embodiment for each activation subsequence. These values are the positive output voltage value of the electric power supply source divided by three, zero or the negative output voltage value of the electric power supply source divided by three, the value of the output voltage of the electric power supply source being

$$\frac{{V}_{dc}}{2} .$$

The method 10 and the device 20 forming the subject matter of the presently disclosed embodiment make it possible to eliminate the amplification means currently used, such as output voltage boosters of the electric power supply source, for example.

FIG. 2 depicts a particular aspect 20 of a device forming the subject matter of the presently disclosed embodiment invention which comprises:

two three-phase inverters, 225 and 235, each inverter, 225 or 235, being controlled via a modulation of at least six space vectors, the output voltage of each inverter being given by a space vector referred to as the “reference space vector”

means for applying 255 an activation sequence 260 to the space vectors of one inverter 225,

means for applying 255 an activation sequence 265 to the space vectors of the other inverter 230,

means for subtracting the reference space vector of one inverter 225 from the reference space vector of another inverter 235, and

means for connecting 205 and 210, to an electric power supply source 200.

The inverter 225 comprises six power switches 230 which are controlled by the means for applying 255 an activation sequence 260. Three pairs of power switches 230 are mounted in parallel. The power switches 230 have two states, open or closed. For activating one power switch 230 per pair, in open or closed position, the other power switch 230 is controlled in the other position.

The space vectors V₀, V₁, V₂, V₃, V₄, V₅, V₆, V₇, each correspond to a different activation combination of the six power switches 235. The activation sequence 260 of the space vectors corresponds to an activation sequence of the power switches 230. The vector V₀ corresponds to the closure of the first switches 230 receiving the current for each pair of switches 230. The vector V₇ corresponds to the opening of the first switches 230 receiving the current for each pair of switches 230.

The inverter 235 comprises six power switches 240 which are controlled by the means for applying 255 an activation sequence 265. Three pairs of power switches 240 are mounted in parallel. The power switches 240 have two states, open or closed. For activating one power switch 240 per pair, in open or closed state, the other power switch 240 is controlled in the other state.

The space vectors V₀, V₁, V₂, V₃, V₄, V₅, V₆, V₇, each correspond to a different activation combination of the six power switches 240. The activation sequence 265 of the space vectors corresponds to an activation sequence of the power switches 240. The vector V₀ corresponds to the closure of the first switches 240 receiving the current for each pair of switches 240. The vector V₇ corresponds to the opening of the first switches 240 receiving the current for each pair of switches 240.

A power switch, 230 or 240, may be a diode and a transistor mounted in parallel. Preferably, the power switches, 230 or 240, are MOSFET (Metal Oxide Semiconductor Field Effect Transistor) transistors or IGBT (Insulated Gate Bipolar Transistor) transistors.

The power supply means 200 with a DC current source may be an autonomous electric power supply source or an electricity source connected to the national network.

The means for connecting, 205 and 210, may be electric conductors. The means for connecting may comprise capacitors 215 and 220 filtering the current ripples of a DC bus. The capacitance value of the capacitors 215 and 220 depends on the current ripple level of the DC bus. The DC bus is the electric current at the output of the power supply means 200.

Preferably, the inverters 225 and 235 are identical.

The inverter 225 is preferably the inverter O1 described in the description of FIG. 1 and the inverter 235 is preferably the inverter O2 described in the description of FIG. 1.

Each activation sequence, 260 or 265, is preferably a successive, periodic activation of each power switch, 230 or 240. The activation sequences 260 and 265 are preferably the activation sequences described in the description of FIG. 1.

Each inverter, 225 or 235, has three electric conductors at the output and three currents are available at the output of each inverter, 225 or 230. Preferably, the output signals of each conductor are similar but phase-shifted with respect to each other by 2π/3 radiants. The electric motor 245 comprises three phases 250 referred to as pa, pb or pc in accordance with the description of FIG. 1. Each electric conductor is connected to a phase, pa, pb or pc, of the electric motor 245.

Preferably, the electric motor 245 is a three-phase asynchronous motor.

The means for applying 255 an activation sequence 260 to the space vectors of one inverter 225 and means for applying 255 an activation sequence 265 to the space vectors of the other inverter 230 are preferably a microcontroller generating a digital control signal during the period Ts.

The means for subtracting the reference space vector of one inverter 225 from the reference space vector of another inverter 235 are preferably implemented by connecting one inverter 235 to the negative pole of the electric power supply source 200 and one inverter 225 to the positive pole of the electric power supply source 200. Since the voltages delivered to the inverters, 225 and 235, are of opposite signs, the subtraction is performed automatically.

Preferably, the device 20 is such that each element of each inverter, 225 or 235, is symmetrically connected with respect to the electric motor 245.

The device 20 implements the method 10 described in the description of FIG. 1.

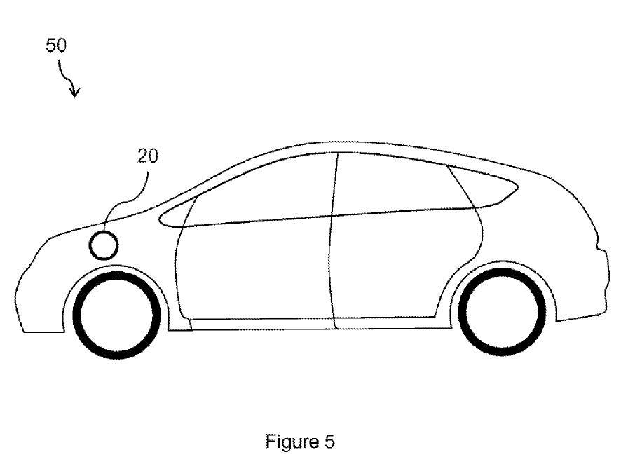

The representations the results of which are represented in FIGS. 3a, 3b, and 4, are representations made by means of an aspect 20 of a device forming the subject matter of the presently disclosed embodiment.

FIGS. 3a and 3b depict reference vectors in an orthonormal reference frame (α, β) in the context of the presently disclosed embodiment.

FIG. 3a, represents a graph 30a in the orthonormal reference frame (α, β), representative of:
points 305 of a curve of values of a reference vector of an inverter O1 or O2,
the reference vectors, \vec{V}_{ref}¹ and \vec{V}_{ref}² at the output of the inverter O1 and the inverter O2 respectively, during the first subsequence of the activation sequences 260 and 265, and
the space vectors V₀, V₁. V₂, V₃, V₄, V₅, V₆, V₇, of each inverter, O1 and O2.

The six space vectors of each inverter, V₁, V₀, V₃, V₄, V₅, V₆, are defined as having the same norm and such that the angle between the direction of a vector Vᵢ and the direction of a vector Vᵢ₊₁, with i an integer between one and six, is sixty degrees. In defining the origin of the six space vectors V₁, V₂, V₃, V₄, V₅, V₆, at the same determined point of an orthonormal reference frame (α, β), the extremities of the space vectors V₁, V₂, V₃, V₄, V₅, V₆, define a regular hexagon. The vector V₁ is defined as being parallel to the axis a of the orthonormal reference frame (α, β).

The two vectors V₀ and V₇ correspond to zero vectors and are positioned at the center of the regular hexagon defined by the space vectors V₁, V₂, V₃, V₄, V₅, V₆.

The vector \vec{V}_{ref}¹ is in transition between the space vector V₁ and the space vector V₂ according to the description of the first activation subsequence of the inverter O1 described in the description of FIG. 1.

The vector \vec{V}_{ref}² is in transition between the space vector V₃ and the space vector V₄ according to the description of the first activation subsequence of the inverter O1 described in the description of FIG. 1.

Graph 30b in FIG. 3b compares the maximum values of the reference vectors for a conventional space vector modulation and for a modulation as described in the description of FIG. 1, in an orthonormal reference frame (α, β) for positive values of α and β

Graph 30b represents:
points 310 of a curve of values of a vector \vec{V}_{ref,CSVM}¹ representative of a reference voltage for a conventional space vector modulation,
points 305 of a curve of values of a vector \vec{V}_{ref}¹ representative of a reference voltage for a modulation as described in FIG. 1,
a curve 300 representative of a reference voltage for a modulation as described in the description of FIG. 1, extrapolated from the points 305,
a vector 320 representative of the space vector V₁ of the inverter, O1 or O2, and
a vector 315 representative of the space vector V₂ of the inverter, O1 or O2.

It can be seen that the maximum values of the reference vectors for a conventional space vector modulation are less than the maximum values of the reference vectors for a modulation as described in the description of FIG. 1.

FIG. 4 depicts a graph 40 resulting from a vector simulation, for an aspect of a device 20 forming the subject matter of the presently disclosed embodiment, in the orthonormal reference frame (α, β), representative of:
points 310 of a curve of values of a vector V_{ref,CSVM}¹ representative of a reference voltage for a conventional space vector modulation,
a curve 300 representative of a reference voltage \vec{V}_{ref}¹ for a modulation as described in the description of FIG. 1, extrapolated from the points 305,
reference vectors, \vec{V}_{ref}¹ and \vec{V}_{ref}², at the output of the inverter O1 and the inverter O2 respectively, during the first subsequence of the activation sequences 260 and 265, and
the vector 400 representative of the voltage inducing the available electric current at the input of the electric motor 245.

It can be seen in FIG. 4 that the norm of the vector 400 is greater than the norm of the vectors \vec{V}_{ref}¹ and \vec{V}_{ref}². It can also be seen that the norm of the vector 400 is greater than the maximum attainable value at the output of a conventionally modulated inverter or according to the description of FIG. 1. The norm of the vector 400 corresponds to the available voltage at the input of the electric motor 245 of the device 20 forming the subject matter of the presently disclosed embodiment.

FIG. 5 depicts a particular aspect 50 of a vehicle forming the subject matter of the presently disclosed embodiment.

The vehicle 50 may be any type of electric or hybrid vehicle, such as an automobile, a train or a tram, for example.

The vehicle 50 comprises an aspect 20 of a device forming the subject matter of the presently disclosed embodiment. The aspect 20 of the device forming the subject of the presently disclosed embodiment is preferably connected to DC power supply means of the vehicle 50 and to a three-phase electric motor of the vehicle 50.

What is claimed is:

1. A current conversion method for a vehicle comprising:
a three-phase electric motor,
two three-phase inverters, each inverter being controlled via a modulation of at least six space vectors, the output voltage of each inverter being given by a space vector referred to as a “reference space vector”,
the method comprising the following steps:
applying an activation sequence to the space vectors of one inverter,
applying an activation sequence to the space vectors of the other inverter,
subtracting the reference space vector of one inverter from the reference space vector of another inverter and
supplying the electric motor with electric current, the voltage inducing the electric current being relative to the vector resulting from the subtraction.

2. The method as claimed in claim 1, wherein the activation sequences are configured so that the reference vectors are phase-shifted.

3. The method as claimed in claim 1, wherein each activation sequence of an inverter is configured so that two space vectors of the inverter, V_{I} and Vᵢ₊₁, with i an integer between one and six, are activated consecutively by the activation sequence.

4. The method as claimed in claim 3, wherein, for an inverter Oₙ controlled according to a conventional modulation of eight space vectors Vi with i an integer between zero and seven, with n an integer between one and two:
the conventional duty cycle, ∝_{i,CSVM}ⁿ, of a vector Vᵢ activated by the activation sequence is given by the following formula:
$${∝}_{i , CSVM}^{n} = {V}_{ref , pu}^{n} ( \frac{sin ( i \frac{π}{3} - {θ}_{n} )}{sin ( \frac{π}{3} )} )$$
the conventional duty cycle, ∝_{i+1,CSVM}ⁿ of the vector Vᵢ₊₁ activated consecutively by the activation sequence is given by the formula:
$${∝}_{i + 1 , CSVM}^{n} = {V}_{ref , pu}^{n} ( \frac{sin ( {θ}_{n} - ( i - 1 ) \frac{π}{3} )}{sin ( \frac{π}{3} )} )$$
where, i is an integer between one and six, θₙ is the phase of the conventional reference vector, and V_{ref,pu}ⁿ is the ratio between the norm of the conventional reference vector of the inverter n and the norm of the space vector Vᵢ,
the conventional reference space vector, \vec{V}_{ref,CSVM}ⁿ, of the inverter activated by the activation sequence is given by the following formula:
$${{V}^{->}}_{ref , CSVM}^{n} = {∝}_{i , CSVM}^{n} {{V}^{->}}_{i} + {∝}_{i + 1 , CSVM}^{n} {{V}^{->}}_{i + 1} + ( \frac{1 - {∝}_{i , CSVM}^{n} - {∝}_{i + 1 , CSVM}^{n}}{2} ) ( {{V}^{->}}_{0} + {{V}^{->}}_{7} )$$

5. The method as claimed in claim 4, wherein, for an inverter Oₙ, with n an integer between one and two:
the modified duty cycle, ∝ᵢⁿ, of a vector Vᵢ activated by the activation sequence is given by the following formula:
$${∝}_{i}^{n} = \frac{1}{2} - \frac{{∝}_{i + 1 , CSVM}^{n} - {∝}_{i , CSVM}^{n}}{2} = \frac{1}{2} - {V}_{ref , pu}^{n} sin ( {θ}_{n} - ( i - \frac{1}{2} ) \frac{π}{3} )$$
the modified duty cycle, ∝ᵢ₊ᵢⁿ, of the vector Vᵢ₊₁ activated consecutively by the activation sequence is given by the formula:
$${∝}_{i + 1}^{n} = \frac{1}{2} + \frac{{∝}_{i + 1 , CSVM}^{n} - {∝}_{i , CSVM}^{n}}{2} = \frac{1}{2} + {V}_{ref , pu}^{n} sin ( {θ}_{n} - ( i - \frac{1}{2} ) \frac{π}{3} )$$
where, i is an integer between one and six, θₙ is the phase of the conventional reference vector, and V_{ref,pu}ⁿ is the ratio between the norm of the conventional reference vector of the inverter n and the norm of the space vector Vᵢ,
the modified reference space vector, \vec{V}_{ref}ⁿ, of the inverter activated by the activation sequence is given by the following formula:
$${{V}^{->}}_{ref}^{n} = \frac{{{V}^{->}}_{i} + {{V}^{->}}_{i + 1}}{2} + ( {∝}_{i + 1 , CSVM}^{n} - {∝}_{i , CSVM}^{n} ) \frac{{{V}^{->}}_{i + 1} - {{V}^{->}}_{i}}{2} = {∝}_{i}^{n} {{V}^{->}}_{1} + {∝}_{i + 1}^{n} {{V}^{->}}_{i + 1}$$

6. The method as claimed in claim 1, in which the activation sequences are independent.

7. A current conversion device, comprising:
two three-phase inverters, each inverter being controlled via a modulation of at least six space vectors, the output voltage of each inverter being given by a space vector referred to as a “reference space vector”.
means for applying an activation sequence to the space vectors of one inverter,
means for applying an activation sequence to the space vectors of the other inverter,
means for subtracting the reference space vector of one inverter from the reference space vector of another inverter and
means for connecting to an electric power supply source.

8. A vehicle, comprising a device as claimed in claim 7, and a three-phase electric motor.
